(19) United States
(12) Patent Application Publication
(10) Pub. No.: US 2014/0224744 A1
(43) Pub. Date: Aug. 14, 2014

(54) METHOD FOR WATER TREATEMENT AND FLOC AND SLUDGE COLLECTION

(71) Applicant: Thomas A. DeBusk, Cocoa, FL (US)

(72) Inventor: Thomas A. DeBusk, Cocoa, FL (US)

(21) Appl. No.: 14/240,838

(22) PCT Filed: Aug. 30, 2012
(86) PCT No.: PCT/US2012/053149

§ 371 Date: Apr. 4, 2014

Related U.S. Application Data
(60) Provisional application No. 61/529,394, filed on Aug. 31, 2011.
(60) Provisional application No. 61/665,169, filed on Jun. 27, 2012.

(51) Int. Cl. C02F 1/52

(52) U.S. Cl. CPC C02F 1/52
USPC 210/702; 210/747.5

(57) ABSTRACT

A method for removing contaminants from a body of water is provided by positioning a flexible containment vessel within the body of water and moving water to be treated from the body of water into the flexible containment vessel. The water to be treated typically contains contaminated organic or inorganic suspended solids, and provides shape to the flexible containment vessel. The solids accumulate in at a bottom portion of the containment vessel in a collection area. After preventing water flow from the body of water into the containment vessel, the treated water and the accumulated solids are removed from the collection area resulting in a collapsing of the flexible containment vessel and a concentrating of the solids to a reduced collection area. The solids are now more efficiently removed from the reduced collection area within the collapsed containment vessel.

### CROSS REFERENCE TO RELATED APPLICATION

This application claims the benefit of U.S. Provisional Application No. 61/529,394, filed Aug. 31, 2011, for FLOC and Sludge Management System for Water Treatment and Associated Methods, and U.S. Provisional Application No. 61/665,169, filed Jun. 27, 2012 for Water Treatment System and Method for FLOC and Sludge Collection, the disclosures of which are hereby incorporated by reference in their entirety.

### FIELD OF INVENTION

The present application is directed to systems and methods for treating water and, more particularly to such systems and methods utilizing chemical coagulation.

### BACKGROUND

Chemical treatment of surface waters and wastewaters typically involves an addition of a coagulant (and at times, a coagulant aid and/or buffer) to a water stream. During or following a brief mixing period, a coagulation reaction occurs, small chemical floc particles coalesce, and a solid precipitate, which selected pollutants are either entrained in or adsorbed to, settles out from the water column. In conventional water and wastewater treatment plants, this floc or sludge settling occurs in engineered, steel and/or concrete clarifiers designed to allow for rapid settling times, and effective withdrawal, typically by pumping, of the settled floc material. The bottom of these clarifiers is typically equipped with a deep sump, along with moving mechanical baffles or rakes that convey settled floc to a sump region, from where it is removed by pumping.

There has been increased interest in chemically treating surface waters (e.g., streams, ponds and lake waters, stormwater runoff, and the like) and industrial, agricultural, or municipal wastewaters on a very large scale. However, it is extremely expensive to build conventional clarifiers to treat such high flow volumes. Moreover, many such flows, such as rainfall-generated runoff, enter receiving bodies by gravity flow over the landscape or via defined conveyances (e.g., canals), and therefore considerable energy is needed to pump these flows up to enter an above-ground clarifier.

The earliest stormwater runoff chemical treatment systems utilized a coagulant storage facility and flow-proportional dosing pump, where the coagulant was dosed to a runoff stream, and the resulting floc would simply settle in the receiving water, such as a retention pond or natural pond or lake. The quiescent nature of the receiving water body would provide favorable conditions for floc settling, and it therefore would serve as an effective “clarifier.” Over time, however, it was found that large quantities of floc would accumulate, which must be removed from the body of water.

Removal of floc material from water bodies has proven inefficient and problematic. Efficient removal of this material entails the extraction of fairly concentrated floc, with a minimal volume of overlying water. However, settled floc is difficult to remove by pumped or gravity suction. A suction line deployed at one location, such as in a sump or low spot in a pond, can readily evacuate the nearby floc, but due to the tendency of the floc (and many biological types of sludge) to maintain a steep angle of repose underwater, an opening or cavity quickly forms in a settled floc “blanket,” and from that point on, mainly overlying water (and little or no floc) is removed from the pond via the fixed suction line. Alternatively, mobile suction dredges have been utilized, whereby the suction device is moved throughout the bottom of the pond. While this improves the ability of the suction line to capture concentrated floc materials, it introduces somewhat complicated machinery and control instrumentation for guiding the dredge suction head.

Therefore, it would be beneficial to provide a system and method for improving the efficiency of water treatment using coagulation by improving the floc-removal process. Such a system and method would be desirable for municipal and industrial biological wastewater treatment systems the typically utilize ponds for biosolids or sludge settling.

### SUMMARY OF INVENTION

The teachings of the present invention are directed to systems and methods for highly efficient and effective water treatment.

One method aspect of the invention comprises removing contaminants from a body of water and may include positioning a containment vessel within a body of water, wherein the containment vessel comprises a flexible wall; moving water to be treated from the body of water into the containment vessel, wherein the water to be treated contains at least one of organic and inorganic suspended solids having a contaminant therein, and wherein the water moving step provides a first wall shape to the containment vessel; allowing the solids to accumulate in the treated water at a bottom portion of the containment vessel in a collection area thereof; preventing water flow from the body of water into the containment vessel; removing the treated water and the accumulated solids from the collection area; continuing the removing step sufficient for collapsing the containment vessel and concentrating the solids to a reduced collection area; and removing at least a portion of the solids from the reduced collection area within the collapsed containment vessel.

Another method may comprise dosing the water to be treated with a chemical coagulant to form treated water, and wherein the solids accumulating step comprises permitting coagulation and flocculation to form floc. Yet further, the method may include permitting clarified water to form within an upper portion of the containment vessel, and draining at least a portion of the clarified water from the upper portion of the containment vessel.

One embodiment according to the teachings of the present invention may comprise a containment vessel or settling vessel constructed of a flexible material that may be positioned above ground, above a water table, or in a body of water. The settling vessel may include a concave shaped cross section, such as a hemisphere, cone shape or an elongated trench. The settling vessel may include a suction point adjacent a lowest portion of the settling vessel. By way of example, locating the suction point may comprise plumbing downward from a surface of the body of water, or through a side wall or bottom wall of the vessel. The suction point provides an effective and simple floc or solids removal. Applying suction using a pump connected to an effluent line enables the floc or solids to accompany any associated water as it is removed from the bottom of the vessel.

The settling vessel or containment vessel may be controlled by several factors including the chamber or multiple chambers plumbed in series for desirably promoting sufficiently low velocity, quiescent conditions, to enhance solids (particle) settling. Further, when suction is applied at a preselected point or multiple points in the vessel, the vessel or chamber within the vessel collapses in such a way that floc/sludge or solids flows freely to a preselected area. Water from outside the vessel is prevented from entering the vessel or chamber and diluting contents within the containment vessel, and thus enhance efficiency of the removal process.

Yet further, the chamber may capitalize on the shape of a vessel or pond to minimize infrastructure costs. A bottom fabric of the chamber may rest on the bottom of the pond or vessel as it begins to fill with floc, thereby minimizing the amount of flotation required at the chamber's surface.

### BRIEF DESCRIPTION OF DRAWINGS

Embodiments of the invention are described by way of example with reference to the accompanying drawings in which:

FIG. 1 is a diagrammatical cross-sectional illustration of another embodiment of a water treatment system according to the teachings of the present invention using a unitary settling container positioned in a body of water;

FIG. 1A is a diagrammatical cross-sectional illustration of a flexible containment vessel suspended within a body of water, wherein water to be treated substantially fills the containment vessel;

FIG. 1B is a diagrammatical cross-sectional illustration of a typical containment vessel within a body of water, wherein water to be treated fills the containment vessel and solids allowed to settle are pumped out of the vessel, and wherein such typical pumping results in a void or cavity formed within the solids thus rendering removal undesirably inefficient;

FIG. 1C is a diagrammatical cross-sectional illustration of the flexible containment vessel of FIG. 1A, wherein reducing the volume of water in the containment vessel results in walls of the vessel collapsing and causing settled solids to be concentrated within a definable collection area;

FIG. 2 is a diagrammatical cross-sectional view of a further embodiment of the invention comprising a water treatment system using multiple settling containers;

FIG. 3 illustrates one embodiment of the invention comprising an octagonal chamber, filled with water, and containing weighted chains running from the periphery to a central point, thus modeling a large system such as a small pond; and

FIG. 4 illustrates an embodiment of the invention comprising a rectangular chamber, originally containing water, following evacuation of the water by a centrally located suction pipe positioned just below the surface of the water, wherein the containment or chamber fabric collapses inwards and upwards, pushing all water to the central location.

### DETAILED DESCRIPTION OF EMBODIMENTS

The present invention will now be described more fully hereinafter with reference to the accompanying drawings, in which embodiments of the invention are shown by way of illustration and example. This invention may, however, be embodied in many forms and should not be construed as limited to the embodiments set forth herein. Rather, these embodiments are provided so that this disclosure will be thorough and complete, and will fully convey the scope of the invention to those skilled in the art.

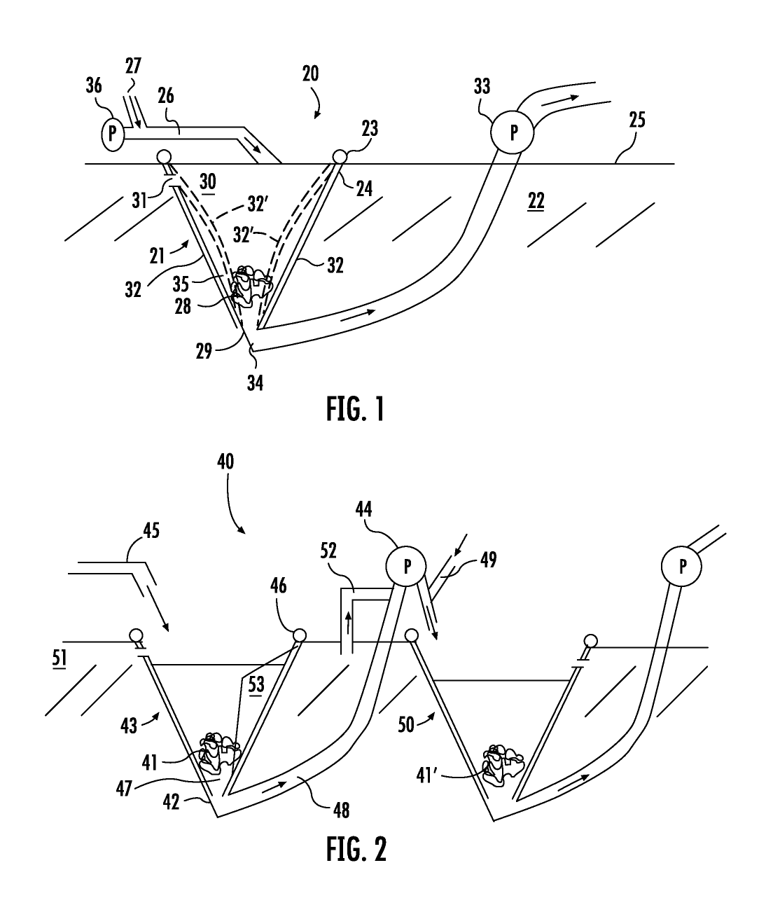

With reference initially to FIG. 1, one embodiment of the present invention include a system 20 having a settling vessel 21 comprising an enclosed cylinder, cube, cone or trough deployed in a water body 22 (pond or lake). The settling vessel 21 preferably comprises a flexible barrier material (e.g., plastic or vinyl). A floating boom 23 is affixed around a top edge 24 of the settling vessel 21. Because the vessel 21, a settling basin by way of example, is immersed in the body of water 22, only minimum infrastructure is required, mainly that needed to maintain the appropriate shape of the floating boom 23 components (e.g. square, rectangle, circle) on the water's surface 25.

In use, during treatment operations, incoming water 26 (runoff or wastewater) is dosed with a coagulant 27, and fed either by gravity or pumping into the settling vessel 21. The resulting floc 28 settles adjacent a bottom 29 of the settling vessel 21, while treated, clarified water 30 flows out through an aperture 31 positioned near the water surface 25 along the top edge 24 of one or more sides 32 of the vessel 21.

Over time, as the floc 28 settles and collects in the settling vessel's bottom 29, floc removal efforts are initiated, by way of example. In one embodiment of the invention including a floc-removal method, once a critical volume of the floc 28 has accumulated, the inflowing water stream 26 is curtailed, and the overflow aperture 31 is closed, resulting in the settling vessel 21 that is substantially sealed, with little possibility of entry of outside water from the body of water 22.

At least one pump 33 having suction head 34 situated at one or more locations adjacent the bottom 29 of the vessel 21 is turned on. As the floc 28 and water 35 from the settling vessel 21 are evacuated, the vessel side or wall 32 contracts to wall 32′, as illustrated by way of example with reference again to FIG. 1. Since, when fluid is removed, and while none can enter, the outside water pressure collapses the flexible wall 32 of the vessel 21. The settling vessel's structure typically causes a steepening of the internal flexible wall 32, promoting flow of the vessel water 35 and the floc 28 to the suction head 34. Once a desired portion of the contents of the settling vessel 21 are evacuated, a second pump 36 can be used to feed water 22 (without floc therein) back into the settling vessel 11, causing the original shape of the vessel 21 to be assumed. The overflow aperture 31 is then opened, and the system 20 is ready for continued operation as a floc settling and containment device.

By way of further example and to emphasize a problem in the art being solved by the teachings of the present invention, consider the system 20 and method used for removing contaminants from the body of water 22 with reference now to the diagrammatical illustrations of FIGS. 1A and 1B. As above described, the containment vessel 21 having flexible walls 32 is placed within the body of water 22 and filled with water to be treated 22T from that water body 22. The water to be treated my be allowed to spill into the vessel 21 or pumped 26 and may be appropriate for efficiency. The water to be treated 22T will typically be known to contain contaminated organic and inorganic suspended solids that undesirably pollutes the body of water 22. With the water to be treated 22T at substantially filling the contaminant vessel 21, a first wall shape 32 is provided to the vessel 21.

With continued reference to FIG. 1A, and as is typical in the art, solids (floc 28 for the one example herein described by way of example) are allowed to accumulate at a bottom portion 21B of the vessel 21, a collection area. However, as is well known in the art, simply pumping out 38 the solids 28 typically results in creation of a void 28V and thus inefficiency in removing the solids.

As above described, solution is provided by embodiments of the invention as illustrated now with reference now to FIG. 1C. Water from the body of water 22 is prevented from entering the containment vessel 21. The treated water 22T and the accumulated solids 28 are removed from the collection area 21B, by way of pumping 38 either from below or above, by way of example. The continued removal of the treated water 22T and the accumulated solids 28 reduces the volume of fluid in the vessel 21 and thus causes pressure (P) from the body of water 22 to deform and collapse walls 32 into a wall shape 32′. As a result, a void in the solids 28 is essentially prevented from forming and the solids are efficiently removed from the vessel 21.

Optionally, clarified water 30 accumulating at an upper portion 21U of the vessel 21 may be initially drained or pumped (see Arrow 30′) from the vessel 21 after the water from the body of water is prevented from entering the vessel. Initially removing the clarified water 30 will initiate the vessel collapsing.

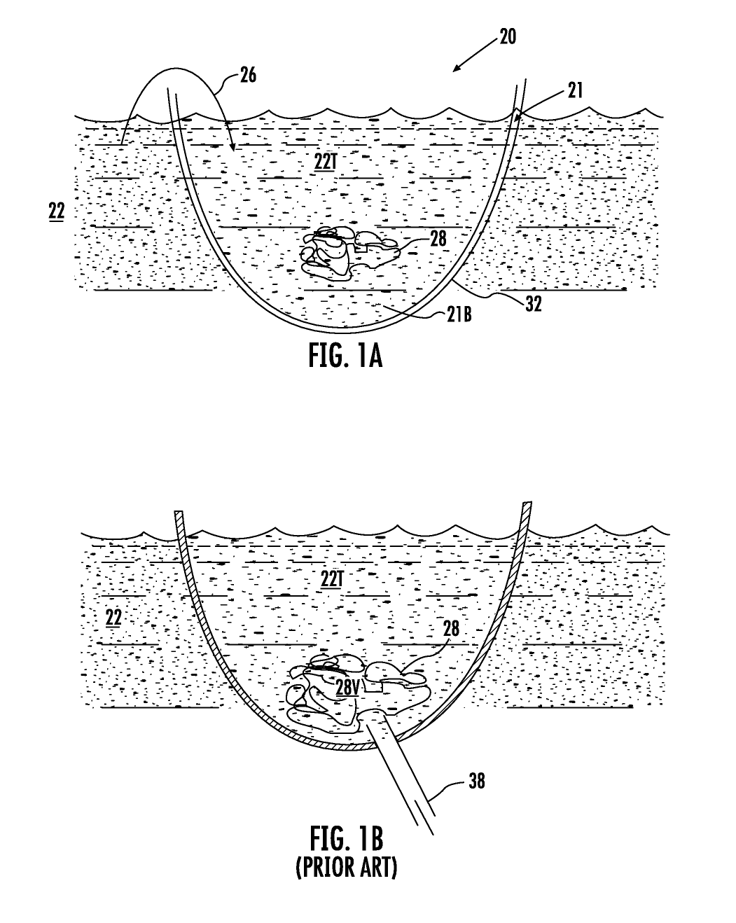

In another embodiment of the invention as referenced now to FIG. 2, in a system 40, a preselected volume of floc 41 is permitted to accumulate or accrue adjacent a bottom 42 of a first settling vessel 43. A pump 44 is used to evacuate floc 41 at approximately the same rate at which it is being produced. In this embodiment, operation comprising a feeding of coagulant-dosed waters 45 from the body of water to be treated adjacent a top 46 of the first settling vessel 43 is therefore substantially continuous and concomitant with ongoing floc removal.

With continued reference to FIG. 2, floc 41 and floc-laden water 47 removed from the bottom 42 of the first settling vessel 43 can be substantially continuously introduced via pipe 48 into a second water stream 52, which can be receiving either no coagulant or a minimal coagulant dose 49. Thus, at least partial treatment of this second water stream having a minimal coagulant dose 49 is achieved, which may be enhanced by agitation and re-suspension. By way of example, the system 40 capitalizes on the fact that many chemical coagulant flocs exhibit continued ability to adsorb/entrain pollutants, even after their initial formation and settling.

Stream 48, which contains the floc 41 from the first settling vessel 43, is joined by additional untreated water 52 from the water body 51. The “recycled” floc 41′, containing additional material to be removed from the water, can then be allowed to settle in a second settling vessel 50, situated in the water body 51.

Multiple (two or more) uses of the floc material can therefore be accomplished by deploying several settling vessels in the body of water 51, and cycling the floc into the settling vessels in a sequential fashion. When the pollutant removal ability of the floc is exhausted, the floc is pumped from the final settling vessel, here, the second settling vessel 50 to either the shoreline for drying/disposal, or to a vehicle for transport off-site.

The containment vessels 21, 43 herein operated as settling basins, by way of example, can be operated in a top water feed, side water feed, or bottom water feed, depending on floc settling characteristics and other factors. The side and bottom water feed pipes can either be rigid or flexible, depending upon their need to flex as the barrier collapses during the floc removal process. In addition to coagulants such as aluminum, iron, calcium, or lanthanum compounds, buffers (carbonates, hydroxides) and/or coagulant aids (natural or artificial polymers) can be provided in the inflows to one or more of the settling vessels in series, as appropriate. Further, the containment vessels 21, 43 can be equipped with internal baffles 53 to enhance floc settling characteristics.

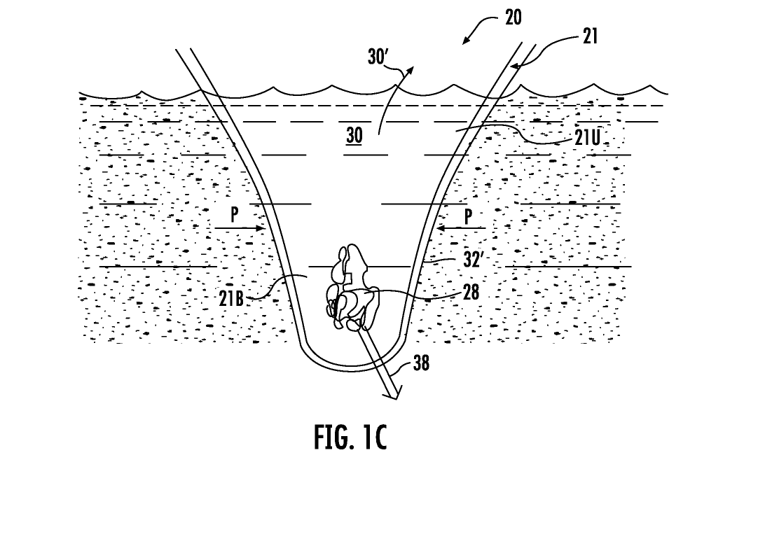

By way of further example, and as illustrated with reference now to FIG. 3, one embodiment of the invention includes a system 60 having a flexible liner 62, or the like, typically made of a plastic material, in an above-ground tank or vessel 64, or in a pond or lake. The liner 62 typically is held slightly above the water's surface 66 by a network of floats 68, essentially creating a discrete “bowl” or chamber 70 within the vessel 64 or pond. The shape of the chamber 70 at the surface 66 can be controlled by an arrangement of the floats 68, as well as by guy wires 72 linked to the shoreline (for pond) or sides 74 (for vessel), or to a rigid structure deployed at the surface 66 of the pond or vessel.

The chamber 70 can occupy the entire volume of the vessel/pond 64, or only a small portion of the vessel/pond. As described earlier with reference to FIG. 2, multiple chambers 70 can be deployed, either connected or operated in parallel, or in series, within the vessel or pond.

Water 76 containing a floc or sludge 78, typically created in an upstream chemical or biological unit process, is fed into the flexible chamber 70 either via a conduit 80 such as a pipe positioned above the floats, or through a pipe connected into the side of the chamber below the water's surface 66. Thus, the chamber 70 can accept either pumped or “gravity” flows. The chamber 70 is designed to promote quiescent (low velocity) conditions favorable for particle settling, and therefore can contain baffles (typically flexible) and assume other dimensions typical of a clarifier to enhance floc/sludge settling within the chamber.

After a certain hydraulic residence time, typically on the order of 30 minutes to several hours, clarified (generally solids-free at this point) water exits the chamber through a surface or subsurface overflow, typically on the opposite end of the chamber 70 from where it was introduced.

The shape of the chamber 70 at the water's surface 66 (at the “float line”) can be circular (or a similar shape, like octagonal, hexagonal), square, or rectangular. Similarly the chamber's depth can vary, depending in part on the depth of the vessel/pond into which it is deployed.

By way of example, as herein presented with continued reference to FIG. 3, one embodiment of the invention comprises an octagonal chamber 70, filled with water 82, and containing weighted chains 84 running from the periphery 86 to a central location 88. This model mimics a large aqueous system that might be 50 feet in diameter and 10 feet deep (a fairly typical size for small ponds in Florida).

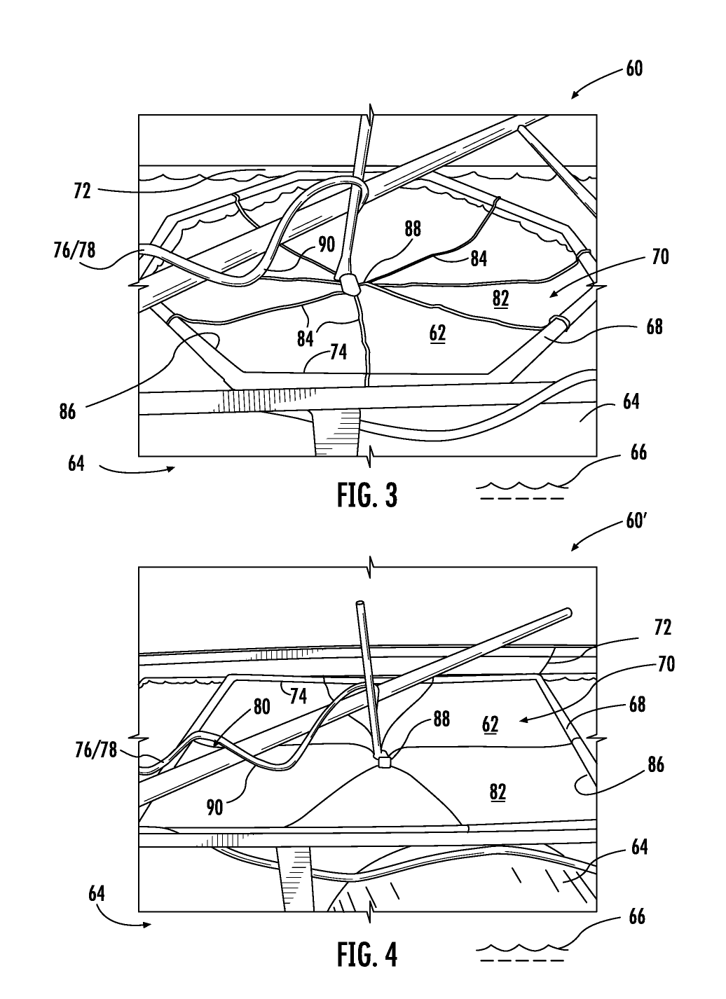

By way of further example, and with reference to FIG. 4, one embodiment comprises a rectangular chamber 70′, originally containing water 82, following evacuation of the water by a centrally located suction pipe 90 placed just below the surface of the water. It should be noticed how the chamber fabric collapses inwards and upwards, pushing all water to the central location 88. The behavior of the chamber 70 with water is similar to how it behaves with floc.

Water can be added and/or removed on either a continuous, batch, or semi-continuous basis. Once a certain amount of floc/sludge has accumulated within the chamber 70 (due to gravity settling) over time, this material is removed by a pump, or in some cases (as in an above ground vessel), gravity suction, as above described with reference to FIGS. 1 and 2. The suction intake can be introduced either from above the water to varying depths in the chamber or containment vessel, or up from the bottom through an aperture in the bottom (lowest point) of the flexible chamber material. Just prior to floc/sludge removal, all external apertures are sealed, if needed, to prevent or minimize water introduction into the chamber from the outside vessel/pond during the floc removal process. Once the floc removal process is started (i.e. suction pump is turned on), the flexible chamber begins to collapse, due to the evacuation of floc and associated water.

One preferred embodiment of the chamber includes the flexible material collapsing into a generally “central” point (the location of the suction pipe), allowing the floc/sludge to flow freely to a suction point with a minimum of creasing or folding of the chamber material that could capture or “pool” the floc, impeding its progress to the suction point. The weighted chains 84, as noted in FIG. 3, provide one means for minimizing undesirable creasing or folding of the vessel or chamber material.

It should be noted that many floc materials and biological sludges will flow to a stationary suction point, even along a very gradual slope, as long as substantially all the water is evacuated from the vessel. This is because many flocs and types of sludge typically do not exhibit the ability to “stand up” and maintain their vertical orientation unless submerged. Therefore, as water is evacuated from the settling vessel, the floc slumps, and flows along with the water to the pump's suction head. One benefit of the flexible chamber is that it allows the effective removal of floc or sludges without totally evacuating all the water from the vessel/pond (difficult in large ponds where groundwater tables are high), and allows an efficient removal of floc, undiluted by large volumes of unwanted water, without the typical infrastructure needed for a moveable suction point (to “vacuum” floc) or the use of mechanical devices (underwater “rakes”) that convey the floc to a single sump.

As the chamber collapses during floc removal, the floc/sludge flow to the suction point (typically one central location) can be enhanced by fastening weighted chains, individual weights, fabric tubes temporarily pumped full of water or air at the time of floc removal, to the chamber at preselected locations, that help the flexible chamber material collapse in a desirable fashion.

Once floc is evacuated, any previously closed apertures are opened (inflow/outflows, for example), water flow is resumed, and the chamber refills with water and begins functioning again as a clarifier.

By way of further example, the chamber 70 dimensions (e.g., diameter, depth) may be controlled by several factors including the chamber (or multiple chambers plumbed in series) desirably promotes sufficiently low velocity, quiescent conditions, to enhance solids (particle) settling. Further, when suction is applied at a generally centralized “low” point (or in some configurations, multiple “low” points), the chamber collapses in such a way that floc/sludge flows freely to the low point(s). This can be challenging for chambers that have large diameter to depth ratios, so chain weights, water/air bladders, and the like, may be used to ensure the chamber walls collapse in a desirable manner.

Yet further, the chamber capitalizes on the shape of the vessel or pond to minimize infrastructure costs. For example, one desirable embodiment would have the bottom fabric of the chamber rest on the bottom of the vessel as it begins to fill with floc, thereby minimizing the amount of flotation required at the chamber's surface (i.e. flotation would only be needed to keep chamber fabric supported above the water, and not also to support the weight of accumulating floc/sludge).

As will come to the mind of those of skill in the art, now having the benefit of the teachings of the present invention, these methods can be used for managing a host of chemical and biological flocs and sludges. The utility and cost effectiveness will depend in part on the physical and settling characteristics of these materials. As noted above, the flocs/sludges can be removed continuously at a slow rate, or intermittently, such as once a day, week, or month. The actual management approach will typically be dictated by the chemical characteristics of the floc (i.e., whether it can be beneficially re-used), as well as factors such as the volume of the settling vessel(s) relative to floc accumulation rate and settling rate of the floc.

Although the invention has been described relative to various selected embodiments herein presented by way of example, there are numerous variations and modifications that will be readily apparent to those skilled in the art in light of the above teachings. It is therefore to be understood that within the scope of claims supported by this disclosure, the invention may be practiced other than as specifically described.

That which is claimed is:

1. A method for removing contaminants from a body of water, the method comprising:
positioning a containment vessel within a body of water, wherein the containment vessel comprises a flexible wall;
moving water to be treated from the body of water into the containment vessel, wherein the water to be treated contains at least one of organic and inorganic suspended solids having a contaminant therein, and wherein the water moving step provides a first wall shape to the containment vessel;
allowing the solids to accumulate in the treated water at a bottom portion of the containment vessel in a collection area thereof;
preventing water flow from the body of water into the containment vessel;
removing the treated water and the accumulated solids from the collection area;
continuing the removing step sufficient for collapsing the containment vessel and concentrating the solids to a reduced collection area; and
removing at least a portion of the solids from the reduced collection area within the collapsed containment vessel.

2. The method according to claim 1, further comprising dosing the water to be treated with a chemical coagulant to form treated water, and wherein the solids accumulating step comprises permitting coagulation and flocculation to form floc.

3. The method according to claim 1, further comprising:
permitting clarified water to form within an upper portion of the containment vessel; and
removing at least a portion of the clarified water from the upper portion of the containment vessel.

4. The method according to claim 3, wherein the clarified water removing step comprises draining the clarified water from the containment vessel.

5. The method according to claim 1, wherein the steps of moving and removing the water into and out of the containment vessel comprises the step of pumping the water.

6. The method according to claim 1, wherein the step of moving the water to be treated from the body of water into the containment vessel continues until the step of preventing the water flow from the body of water into the containment vessel.

7. The method according to claim 1, wherein the step of moving the water to be treated from the body of water into the containment vessel continues until a preselected amount of the solids has accumulated in the collection area.

8. The method according to claim 1, wherein the step of removing at least a portion of the solids from the reduced collection area within the collapsed containment vessel comprises removing the solids from a lower most portion of the collapsed containment vessel.

9. The method according to claim 8, further comprising pumping the solids from the lowermost portion of the containment vessel.

10. The method according to claim 1, wherein the step of positioning the containment vessel within the body of water comprises providing a float and suspending the containment vessel from the float.

11. The method according to claim 10, wherein the containment vessel is formed by suspending the flexible wall from the float.

12. The method according to claim 10, wherein providing the float comprises providing a float having at least one of a circular shape, a square shape, and a rectangular shape.

13. The method according to claim 1, wherein the step of positioning a containment vessel within a body of water comprises positioning first and second containment vessels, each of the first and second containment vessels having a flexible wall, and wherein the step of removing at least a portion of the solids from the reduced collection area within the collapsed containment vessel comprises pumping the portion of the solids and the water to be treated from the reduced collection area in the first containment vessel into the second containment vessel.

14. The method according to claim 1, wherein the collapsing of the containment vessel and concentrating the solids to a reduced collection area comprises concentrating the solids in a central area of the collapsed containment vessel.
